(19) United States
(12) Patent Application Publication
(10) Pub. No.: US 2013/0293699 A1
(43) Pub. Date: Nov. 7, 2013

(54) DEVICE FOR INSPECTING AND/OR REHABILITATING PIPELINES

(71) Applicant: PROKASRO MECHATRONIK GMBH, Karlsruhe (DE)

(72) Inventor: Ulrich ZIPPERLEN, Stutensee-Blankenloch (DE)

(73) Assignee: ProKASRO Mechatronik GmbH, Karlsruhe (DE)

(21) Appl. No.: 13/875,613

(22) Filed: May 2, 2013

(30) Foreign Application Priority Data
May 4, 2012 (DE) 10 2012 009 046.3

(51) Int. Cl. G01N 21/88

(52) U.S. Cl. CPC G01N 21/88
USPC 348/84

(57) ABSTRACT

A device for inspecting and/or rehabilitating pipelines includes a camera or a tool arranged at a carrier that can be passed through the pipeline. To enable the device to pass through pipelines having bends, as used in house service connections, a first cross section of the carrier, taken in a first plane, which includes a central longitudinal axis of the carrier, an essentially straight or concave underside with outer ends. End-side sections of a top side extend upwardly in an arc-shaped and convex manner and away from the respective outer end of the underside in the direction of the opposite end thereof. The radius of curvature or radii of curvature of the end-side sections of the top side of the first cross section, equals (equal) more than 50% of the maximum distance of the underside from the top side.

### CROSS REFERENCE TO RELATED APPLICATIONS

This application claims the benefit of priority under 35 U.S.C. §119 of German Patent Application DE 10 2012 009 046.3 filed May 4, 2012, the entire contents of which are incorporated herein by reference.

### FIELD OF THE INVENTION

The present invention pertains to a device for inspecting and/or rehabilitating pipelines, with at least one camera and/or with at least one tool, which is arranged on a carrier that can be passed through the pipeline.

### BACKGROUND OF THE INVENTION

Such devices are known and are widely used especially during the inspection and/or rehabilitation of pipelines, wherein reference shall be made, for example, to DE 10 2009 017 829 B4 or DE 203 18 292 U1. The carrier, which is provided, as a rule, with one or more cameras as well as optionally with a light source, is inserted to this end into the pipeline to be inspected by means of a guide bar, the so-called sliding eel, and the pipeline is inspected for deposits, leaks or the like. If the carrier is equipped, furthermore, with a tool, for example, a milling tool, rehabilitation of the pipeline can be carried out immediately by removing, e.g., deposits in the interior of the pipeline, such as lime, biofilm, etc., by means of the milling tool.

The carrier of prior-art devices is usually of a more or less cylindrical or cuboid shape, and its axial ends as viewed in the axial direction of the pipeline may be rounded in order to facilitate the advancing motion of the carrier in the interior of the pipeline. It is, nevertheless, problematic to pass the carrier of a device of this class through pipe bends, as they are extensively installed especially in house service connections. When passing through such bends, there is a risk that the carrier will be blocked and stuck either at the outer radius of such a pipe bend if the carrier is pushed through the pipeline “from behind” or at the inner radius of the pipe bend if the carrier is pulled through the pipeline “from the front.” This risk is present especially if more or less sharp-edged tools project from the carrier and/or if the free cross section of the pipeline is narrowed at least locally due to deposits on the inner wall precisely in the area of a pipe bend.

DE 100 35 221 C2 describes a device of this class for rehabilitating pipelines, which seeks to eliminate the problem of moving through narrow pipe bends by a section of the carrier carrying the tool being articulated by means of two hinges to an elongated, rotationally symmetrical, essentially cylindrical section of the carrier, wherein one hinge guarantees rotatability of the two carrier sections relative to one another about the central longitudinal axis of the pipeline, while the other hinge guarantees pivotability of the two carrier sections relative to one another about a pivot axis extending at right angles hereto. Both hinges are actuated by a drive unit each, which is arranged in a respective carrier section and with which they are in connection via hollow shaft transmissions. One drawback is the highly complicated design of the carrier including the two motor-actuated hinges, which do, moreover, require additional space for their installation and counteract the most compact design possible, which would be favorable for passing through narrow pipe bends. On the other hand, the design of the carrier, which is, on the whole, very elongated, does not make passage through narrow pipe bends possible despite the pivotability of the tool-carrying section of the carrier.

### SUMMARY OF THE INVENTION

A basic object of the present invention is therefore to improve a device of the type mentioned in the introduction in a simple and cost-effective manner such that it is capable of reliably passing through pipe bends while avoiding the above-mentioned drawbacks at least extensively.

This object is accomplished according to the present invention in a device of the type mentioned in the introduction by a first cross section of the carrier having an essentially straight or concave underside and having end-side sections of a top side extending upwardly in an arc-shaped and convex manner from the outer ends of said underside and extending from the respective outer end of the underside in the direction of the opposite end of said underside. The first cross section of the carrier is taken in a first plane, which plane includes a central longitudinal carrier axis that extends, during use, more or less parallel to a longitudinal axis of a straight section of the pipeline or axially aligned with the longitudinal axis of the straight section the pipeline. The radius of curvature or the radii of curvature of the end-side sections of the top side of the first cross section, which said sections extend upwardly and away from the respective outer ends of the underside in an arc-shaped and convex manner, equals/equal more than 50% of the maximum distance between the underside and the top side.

The shape according to the present invention of the geometry of the carrier makes it possible to pass through pipe bends in a simple manner by the carrier being arranged in relation to the pipe bend such that the underside of the first cross section is positioned at the inner radius of the pipe bend, and the top side of the first cross section is positioned at the outer radius of the pipe bend. With this construction, the sections of the top side of the first cross section, which said sections extend upwardly from the underside of the first cross section in an arc-shaped and convex manner and in the direction of the opposite end of the underside from the respective outer end of the underside, can slide along the outer radius of the pipe bend without the carrier becoming blocked in the interior of the pipe bend. These sections of the top side of the first cross section, which extend in an arc-shaped and convex manner, are also capable of passing through local deposits that may possibly be present in the pipe bend, because the arc-shaped design prevents getting caught at such deposits. The underside of the first cross section of the carrier in the first plane, which may include the central longitudinal axis of the pipeline, i.e., in the plane of curvature of a pipe bend, may be either essentially straight, so that the cross-sectional shape can assume a more or less crescent shape, or it may be bent slightly concavely inwardly, especially with a radius that is more than double, and especially more than three times the radius or the radii of the sections of the top side of the cross section extending in an arc-shaped and convex manner, so that the first cross section of the carrier may have a more or less crescent shape or sickle shape in order to be able to be passed by the inner radius of a pipe bend even better.

The radius of curvature or the radii of curvature of the end-side sections of the top side of the first cross section, which said sections extend upwardly in an arc-shaped and convex manner and away from the respective outer ends of the underside, equals/equal at least 60%, especially at least 70%, preferably at least 80%, of the maximum distance from the underside to the top side in an advantageous embodiment, and this radius of curvature (these radii of curvature) may equal more than 90%, especially about 100% or even somewhat more than 100% of the maximum distance of the underside from the top side of the first cross section according to especially preferred embodiments in order to ensure a more or less crescent-shaped design of the first cross section, which has proved to be ideal for passing the carrier through pipe bends.

Provisions may be made in an advantageous embodiment for a convex transition area with a radius smaller than the radius or radii of the end-side sections of the top side, which extend upwardly in an arc-shaped and convex manner and away from the respective outer end of the underside, being arranged between the outer ends of the essentially straight or concave underside of the first cross section of the carrier in the first plane, which includes the central longitudinal axis of the pipeline axis (the central longitudinal axis lies in the first plane), and the end-side sections of the top side, which said latter sections extend upwardly in an arc-shaped and convex manner and away from the respective outer end of the underside. The transition area of the straight or slightly concave underside of the first cross section of the carrier in the first plane and the sections of the top side extending in an arc-shaped and convex manner is consequently preferably rounded, and the radius of curvature of these convex transition areas is preferably at most half and preferably at most one third of the radius or the radii of the sections of the top side of the first cross section extending in an arc-shaped and convex manner.

Provisions may be made in another advantageous embodiment for the end-side sections of the top side of the first cross section of the carrier, which said sections extend upwardly in an arc-shaped and convex manner and away from the respective outer end of the underside, to be essentially circular arc-shaped in the first plane, which includes the central longitudinal axis of the pipeline, wherein the radius of such a circular arc equals, as was mentioned above, at least 80%, preferably at least 90%, especially at least 100% of the maximum distance between the top side and the underside of the first cross section of the carrier in the first plane. The length of the circular arc-shaped sections should be preferably between 60° and 90°, especially between 70° and 90°.

Provisions may be made according to one embodiment variant for a central section, which extends essentially straight or concavely, more or less in parallel to the underside of the first cross section, i.e., more or less in the axial direction of the pipeline, being arranged between the end-side sections of the top side of the first cross section of the carrier, which said sections extend upwardly in an arc-shaped and convex manner and away from the respective outer end of the underside, in the first plane, which includes the central longitudinal axis of the pipeline. The axial length of the central section of the first cross section of the carrier in the first plane should, at any rate, be smaller than the axial length of the end-side sections of the sections of the first cross section extending in an arc-shaped and convex manner in order to guarantee satisfactory passage through pipe bends. Such a central section of the first cross section is especially advantageous when the carrier of the device is passing through essentially linear pipeline sections by the central section of the cross section ensuring better sliding of the carrier on the inner wall of the pipe.

Provisions are, furthermore, made in a preferred embodiment for a second cross section of the carrier to be essentially circular in a second plane, which second plane is arranged at right angles to the central longitudinal axis of the pipeline
as well as at right angles to the first plane, which includes the central longitudinal axis of the pipeline, and to be optionally straight or convex with a radius of curvature greater than that of the circular second cross section
at the central areas of its underside; and/or
at the central area of its top side. The second cross section of the carrier in the second plane consequently preferably fits essentially the cross section of the pipeline, and the radius of the second cross section may be adapted, for example, to the usually standardized internal cross sections of commonly used pipelines, for example, of such as are used especially in house service connections.

The carrier may be preferably essentially mirror-symmetrical in relation to
the first cross section of the carrier in the first plane, which includes the central longitudinal axis of the pipeline;
and/or
the second cross section of the carrier in the second plane, which is arranged at right angles to the central longitudinal axis of the pipeline
or at right angles to the first plane.

Provisions may be made in another advantageous embodiment for a third cross section of the carrier to be essential rectangular in a third plane arranged at right angles both in relation to the first plane and in relation to the second plane, wherein the corners of this rectangular third cross section are rounded, especially in a circular arc-shaped manner, in order to come into contact during passage through a pipe bend at the wall sections that are outer wall sections in relation to the pipe bend. The width, i.e., the short side of the more or less rectangular third cross section with rounded corners may in turn be adapted to the usually standardized diameters of common pipelines, for example, such as are used especially in house service connections.

As was indicated in the introduction, provisions are made in an advantageous embodiment of a device according to the present invention for the carrier to carry at least one tool, especially a milling tool. To reliably prevent damage to such a tool during the passage of the carrier through a pipeline as well as especially to prevent the tool from becoming jammed or getting caught in the interior of the pipe, especially at a pipe bend, provisions are preferably made by the present invention for the tool to be able to be moved to and fro between an inoperative position, in which it is located within the carrier, and an operating position, in which it projects from the surface of the carrier. The carrier consequently acts for the tool as a housing in the inoperative position thereof, from which the tool can be brought, when necessary, e.g., when a site that requires rehabilitation in the pipeline has been recognized, into its operating position, in which it projects from the carrier up to the inner wall of the pipe. The geometry according to the present invention of the carrier now offers the tool a maximum possible space while satisfactory passage through pipe bends is guaranteed at the same time. It may, of course, be possible, besides, to accommodate in the housing one or more cameras, whose lens is inserted essentially flush into the outer contour of the carrier and is consequently aligned with said outer contour, and at least one light source, which is used to light the interior space of a pipeline to be inspected in order to identify sites that need to be rehabilitated, may, furthermore, be provided in this case.

The tool may, furthermore, be preferably pivoted about a pivot axis, which is especially essentially at right angles in relation to the first cross section of the carrier in the first plane, which includes the central longitudinal axis of the pipeline, so that it can be arranged, at least in its operating position, in which it projects from the carrier, on the one hand, obliquely at a finite angle in relation to the central longitudinal axis of a pipeline to be inspected in order to process the pipe wall, while, on the other hand, it can be arranged more or less in parallel to the central longitudinal axis of a pipeline to be inspected in order to be able to eliminate, for example, more or less complete clogging of the pipeline.

The tool may be able to be moved to and fro between its inoperative position and its operating position in this connection, in principle, in any desired and manner, for example, by means of an (electric) motor, and the tool can be moved to and fro between its inoperative position and its operating position preferably by means of at least one hydraulically, pneumatically or hydropneumatically actuatable piston-and-cylinder unit. The drive of the tool itself may correspondingly be advantageously a hydraulic, pneumatic or hydropneumatic drive.

The tool may be advantageously arranged at at least one of the end-side sections of the top side of the first cross section of the carrier, which said section extends upwardly in an arc-shaped and convex manner and away from the respective outer end of the underside, wherein said first cross section includes the central longitudinal axis of the pipeline, so that the tool projects from the carrier—when viewed in the axial direction of the pipeline, obliquely in the direction of the pipe wall when it has been brought into its operating position.

Especially if the carrier is equipped with a tool, it may, furthermore, be advantageous if the carrier has a fixing means, which is used to fix the carrier in the interior of the pipeline. Such fixing means are known as such and may have, for example, balloons or “air bags,” which can be filled with fluid pressure and are arranged on the outer side of the carrier, and which press the carrier radially against the inner wall of the pipe in their fluid pressure-filled state. For example, blocking means, which can be folded radially out, or telescoping blocking means are likewise known, which are likewise capable of pressing the carrier radially against the inner wall of the pipe and fix the carrier thereby when necessary.

The carrier may advantageously be connected to a sliding eel, which in turn comprises, for example, a plurality of segments connected to one another in an articulated manner, in order to make it possible to move the carrier through a pipeline by means of a motor or manually. Such a sliding eel is advantageously fastened to the carrier pivotably about an axis that is at right angles in relation to the first plane, which includes the central longitudinal axis of the pipeline, in order to pivot the carrier in relation to the sliding eel at right angles to the plane of bending of a pipe bend, through which the carrier is to pass. The pivot axis of the sliding eel is preferably located in the transition area of one of the outer ends of the essentially straight or concave underside of the first cross section of the carrier in a first plane, which includes the central longitudinal axis of the pipeline, and the end-side section of the top side, which said section adjoins said end of the underside and extends upwardly in an arc-shaped and convex manner and away from this end of the underside, i.e., in the area of one of the two, essentially pointed ends of the more or less crescent-shaped first cross section of the carrier in the first plane.

While the carrier may, in principle, also be rotatable, for example, manually, e.g., by means of the sliding eel, about the central longitudinal axis of the pipeline to be inspected in order to make it possible to arrange it with its first cross section in parallel to the plane of curvature of the pipe bend and/or to direct a tool thereof in the direction of a site of the pipeline that needs to be rehabilitated, provisions may, furthermore, be made according to a preferred embodiment for a rotating means designed to rotate said carrier about the central longitudinal axis of the pipeline to be associated with the carrier. Such a rotating means, which may be connected to the carrier, e.g., by means of the sliding eel or a section thereof, may have to this end especially a first part, which—rotating in unison in the axial direction of the pipeline—is connected to the carrier, as well as a second part, which is rotatable in relation to the first part about the central longitudinal axis of the pipeline and which can be fixed on the inner wall of the pipeline. The statements made above concerning an advantageous fixing means of the carrier apply essentially to the fixing means of the second part of the rotating means at the inner wall of the pipeline. Consequently, to rotate the carrier about the central longitudinal axis of the pipeline, the second part of the rotating means can be fixed at the inner wall of the pipe and the second part can be rotated together with the carrier relative to the first part about the longitudinal axis of the pipeline until the carrier assumes the desired alignment in relation to a pipe bend and/or to a site of the pipeline that needs to be rehabilitated and is to be processed by means of the tool thereof.

As far as the drive of a tool of the carrier and/or of the rotating means thereof is concerned, provisions are made in an advantageous embodiment for a drive of a tool of the carrier, especially a hydraulic, pneumatic or hydropneumatic drive, which is used especially both to move the tool between its inoperative position and its operating position and to drive the tool itself and possibly the rotating means, to be arranged outside the carrier. The drive of the tool of the carrier and possibly of the rotating means may be arranged now, for example, in a drive unit, which is connected to the tool of the carrier and possibly to the rotating means by means of lines arranged in the sliding eel.

Further features and advantages of the present invention appear from the following description of an exemplary embodiment with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective view of an embodiment of a device according to the present invention for inspecting and/or rehabilitating pipelines, with a carrier equipped with a milling tool and with a rotating means connected to the carrier via a sliding eel;

FIG. 2 is a side view of the carrier of the device according to FIG. 1 with the plane of the paper being parallel to a first plane, which includes a central longitudinal carrier axis of the carrier (the central longitudinal carrier axis lies in the first plane) that extends, during use, more or less parallel to a longitudinal axis of a straight section of the pipeline or axially aligned with the longitudinal axis of the straight section of the pipeline to be inspected and corresponds to the plane of bending of a pipe bend, through which the carrier shall be moved, with a tool in an operating position in which said tool is pulled out of the carrier;

FIG. 3 is a side view of the carrier of the device according to FIG. 1, which view corresponds to FIG. 2, with the tool in the inoperative position thereof, in which it is pushed into the carrier;

FIG. 4 is a perspective detail view of the carrier according to FIGS. 1 through 3 without tool;

FIG. 5 is a side view of the carrier, corresponding to FIGS. 2 and 3 corresponding to arrow V according to FIG. 4, in the first plane;

FIG. 6 is a front view of the carrier corresponding to arrow VI in FIG. 4 with the plane of the paper being parallel to a second plane, which second plane is arranged at right angles to the first plane and at right angles to the central longitudinal carrier axis and, during use at right angles to the central longitudinal axis of a pipeline to be inspected; and

FIG. 7 is a top view of the carrier corresponding to arrow VII in FIG. 4 with the plane of the paper being parallel to a third plane, which third plane is arranged at right angles to both the first plane (FIG. 5) and the second plane (FIG. 6).

### DESCRIPTION OF THE PREFERRED EMBODIMENTS

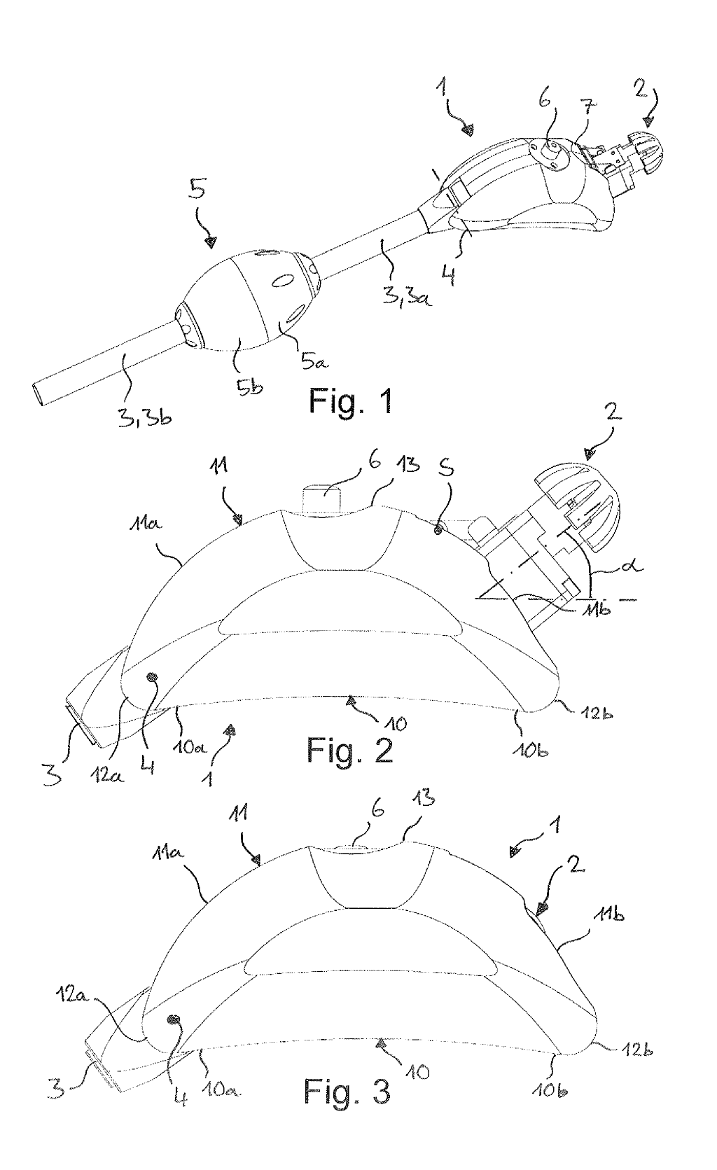

Referring to the drawings in particular, FIG. 1 shows a schematic perspective view of a device for inspecting and/or rehabilitating pipelines, not shown in the drawing. The device comprises a carrier 1, which can be passed through a pipeline to be inspected and which is equipped in this exemplary embodiment with a tool 2 in the form of a milling tool, which is arranged, for example, in the area of the free axial end of carrier 1, which said end is the right-hand end in FIG. 1. The tool 2 can be moved to and fro between an operating position shown in FIGS. 1 and 2, in which the tool projects from the carrier 1 in the direction of the wall of a pipeline to be inspected (not shown), and an inoperative position shown in FIG. 3, in which it is practically accommodated entirely in the interior of the carrier 1 and does not project at least appreciably from the outer contour of the carrier 1, which can be brought about, for example, by means of a, e.g., hydraulically actuatable piston-and-cylinder unit (likewise not shown) accommodated in the interior of the carrier 1. The tool 2 is pivotable, furthermore, by an angle a, which equals about 45° in this case, between its operating position shown in FIG. 2, in which it is arranged in the first plane in relation to the central longitudinal axis of the pipeline to be inspected (not shown) at an angle α in relation to a central longitudinal carrier axis of the carrier that extends, during use, more or less parallel to a longitudinal axis of a straight section of the pipeline to be inspected or axially aligned with the longitudinal axis of the straight section of the pipeline to be inspected (not shown), so that it is capable of processing the inner wall of the pipe. The tool 2 is pivotable into another operating position, not shown in FIG. 2, in which it is arranged coaxial with the central longitudinal carrier axis of the carrier, more or less in parallel to the central longitudinal axis of the pipeline and especially axially aligned with same. The pivoting is about a pivot axis S arranged at right angles to the first plane (i.e., at right angles to the plane of the drawing in FIG. 2), in order to also be able to eliminate cloggings of the pipeline located on the front side of the carrier 1. The carrier 1 may, furthermore, be equipped with one or more cameras and possibly (one) lighting means (neither of which is shown), which are advantageously arranged aligned with the surface contour of the carrier 1 just like the tool 2 thereof in the inoperative position shown in FIG. 3.

In the area of its axial end located opposite the tool 2, which is the left-hand end in FIG. 1, the carrier 1 is connected to a sliding eel 3 used for driving same within a pipeline manually or mechanically in the manner of a guide bar, wherein said sliding eel 3 is fastened to the carrier 1 pivotably especially about an axis 4 extending at right angles in relation to a first plane, which includes the central longitudinal axis of the pipeline and corresponds to the drawing plane according to FIGS. 2 and 3, in order to facilitate passage of said carrier through pipe bends. The sliding eel 3 may have to this end a plurality of segments (not shown) pivotable about axes that are especially parallel in relation to axis 4. The carrier 1 is provided, moreover, with a fixing means 6, which is used to fix the carrier 1 in the interior of the pipeline to be inspected when needed, e.g., when a site that needs to be rehabilitated on the inner wall of the pipeline shall be processed by means of the tool 2. The fixing means 6, which is in its essentially radially outwardly projecting operating position in the situation shown in FIG. 2 and in its inoperative position in which it is withdrawn into the carrier 1 in the situation shown in FIG. 3, has a pin made of a material with high coefficient of friction, e.g., rubber, which said pin can be moved to and fro between the inoperative position and the operating position, in order to make it possible to jam the carrier 1 at a respective pipe section. The fixing means 6 may be moved corresponding to the displacement of the tool 2, for example, by means of a, for example, likewise hydraulically actuatable piston-and-cylinder unit, which is arranged in the interior of carrier 1.

Furthermore, a rotating means 5, which is used to rotate the carrier about the central longitudinal axis of the pipeline to be inspected and is connected to the sliding eel 3, is associated with the carrier 1 by means of a section 3a of the sliding eel 3. The rotating means 5 comprises here a first part 5a, which is connected to the carrier 1, rotating in unison via the section 3a of the sliding eel 3, as well as a second part 5b, which is rotatable in relation to the first part 5a about the central longitudinal axis of the pipeline and which can be fixed at the inner wall of the pipeline when needed. The fixing means of the second part 5b of the rotating means 5, which said fixing means is not shown, may correspond, for example to that 6 of carrier 1. A drive of the tool 2 of the carrier 1, which drive may be, as was mentioned already, e.g., a hydraulic drive, the displacing mechanism thereof, ensuring movement between its inoperative position and its operating position, of the fixing means 6 of the carrier 1 and of the rotating means 5 as well as of the parts 5a, 5b of the rotating means for rotation relative to one another may be arranged especially outside the carrier 1 and outside the rotating means 5, and said drive may be provided, e.g., in an external unit (not shown), which cannot be passed through the pipeline to be inspected and which is connected to the carrier 1 and to the rotating means 5 via hydraulic lines arranged in the sliding eel 3.

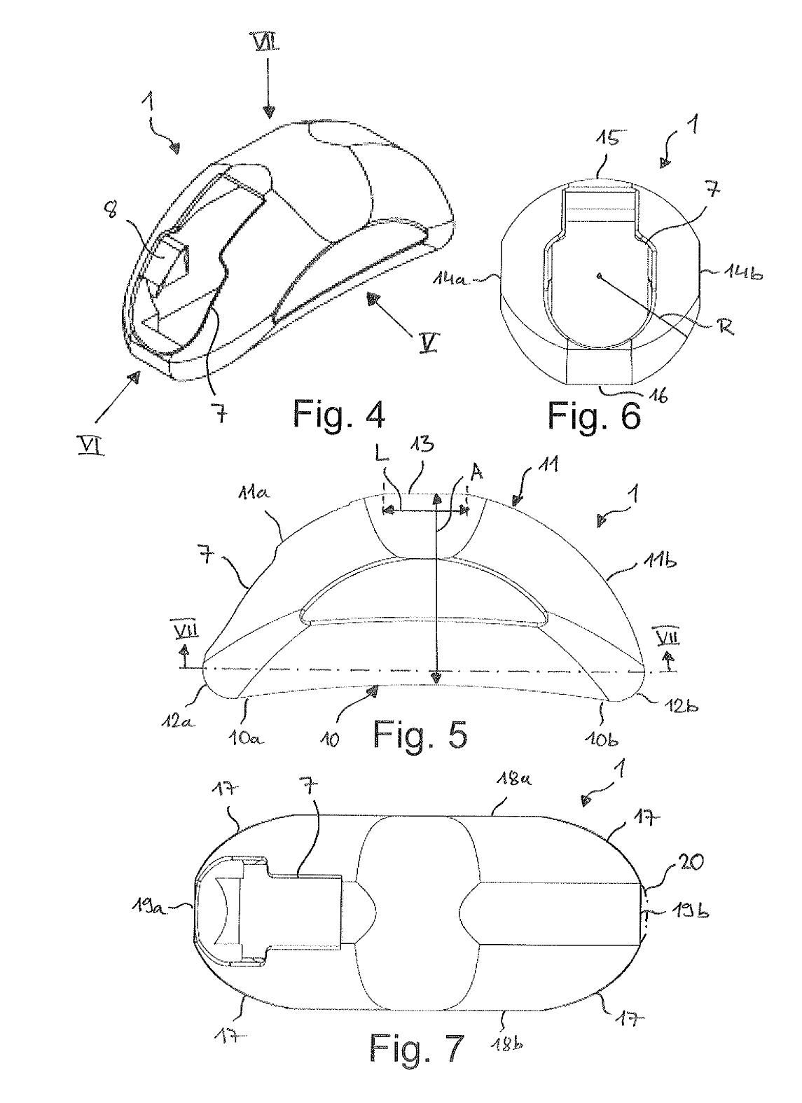

FIGS. 4 through 7 show various views of carrier 1, which is designed in the form of a housing for receiving the tool 2, the camera(s) and lighting means as well as the fixing means 6, wherein the above-mentioned means have been omitted to increase clarity.

As can be determined especially in the side view of the carrier 1 shown in FIG. 5, whose outer contour corresponds to the central cross section of the carrier 1 in a first plane (in the drawing plane of FIG. 5), which includes the central longitudinal axis of a pipeline to be inspected (not shown) and which corresponds to the plane of curvature of such a pipeline, through which the carrier 1 shall be moved, the cross section of the carrier 1 has, in the first plane, a more or less straight or—as in the case of the exemplary embodiment being shown—slightly concavely curved underside 10, from the outer ends 10a, 10b of which, which said ends are the right-hand and left-hand ends in FIG. 5, extend the end-side sections 11a, 11b of a top side 11 upwardly in an arc-shaped and convex manner and away from the respective outer end 10a, 10b of the underside 10 in the direction of the opposite end 10b, 10a thereof. The sections 11a, 11b of the top side 11 of the first cross section, which said sections extend upwardly in an arc-shaped and convex manner, are more or less circular arc-shaped in this exemplary embodiment and have a radius of curvature that equals at least 80% of the maximum distance A between the underside 10 of the first cross section and the top side 11, wherein this radius of curvature is somewhat greater in this exemplary embodiment than said distance A. Moreover, a convex transition area 12a, 12b with a radius smaller than the radius of section 11a, 11b is arranged between the outer ends 10a, 10b of the underside 10 of the first cross section and the section 11a, 11b of the top side, which said latter section extends upwardly in an arc-shaped and convex manner. The first cross section of the carrier 1 in the first plane, which includes the central longitudinal axis of a pipeline (not shown) to be inspected when the central longitudinal carrier axis is aligned therewith, which outer edge profile (outer contour) of the first cross section is recognizable in FIG. 5, consequently has an essentially crescent-shaped or sickle-shaped form, which enables the carrier 1 to be passed through a pipe bend in a reliable manner without the risk of said carrier becoming blocked. In the case of the exemplary embodiment being shown, a central section 13, which extends essentially straight or with a slight concave curvature more or less in parallel to the underside 10 of the first cross section and whose axial length L is shorter than the axial length of the end-side sections 11a, 11b, is provided between the end-side sections 11a, 11b of the top side 11 of the first cross section, which said sections extend upwardly in an arc-shaped and convex manner, and said central section 13 facilitates the passage of the carrier through a pipeline extending in a straight line. The maximum distance A between the top side 13 and the underside 10 of the first cross section may also correspond to the diameter of the pipeline to be inspected and may equal, for example, 100 mm, 150 mm, etc., in case of an imaginary use of the carrier 1 for inspecting house service connections.

FIG. 6 shows a front view of carrier 1 according to FIGS. 4 and 5 in a second plane, which is arranged at right angles to the first plane and at right angles to the central longitudinal axis of a pipeline to be inspected (not shown), through which the carrier 1 shall be moved, wherein the outer contour of the front view shown in FIG. 6 corresponds to a—central—second cross section of the carrier 1 in the second plane (to the plane of the drawing in FIG. 6). As can be determined from FIG. 6, the second cross section of the carrier 1 in the second plane has a more or less circular shape, whose diameter can again correspond approximately to the diameter of the pipeline to be inspected. At the central areas 14a, 14b of the two opposite lateral sections of the second cross section as well as in the central area 15 of the top side thereof and in the central area 16 of the underside thereof, the second cross section deviates from its circular shape to the extent that the central areas 14a, 14b, 15, 16 are flattened, i.e., more or less straight or likewise convex, but have a greater radius of curvature than radius R of the circular second cross section. It can, furthermore, be recognized from FIGS. 4 through 6 that the carrier 1 is mirror symmetrical in relation to the first plane, which includes the central longitudinal axis of the pipeline to be inspected (FIG. 5), as well as in relation to the second plane (FIG. 6) arranged at right angles hereto as well as at right angles to the central longitudinal axis of the pipeline.

Finally, FIG. 7 shows a top view of the carrier 1 according to FIGS. 4 through 6 in a third plane, which is arranged at right angles both in relation to the first plane (FIG. 5), as well as in relation to the second plane (FIG. 6), wherein the outer contour of the top view shown in FIG. 7 corresponds to a third cross section of the carrier 1 according to section line VII-VII in FIG. 5. The third cross section is correspondingly essentially rectangular, and the corners 17 of the third cross section are rounded. The radius of curvature of these rounded corners 17 of the third cross section advantageously corresponds approximately to half the distance of the two long sides 18a, 18b of the rectangle, wherein the distance of the two long sides 18a, 18b may in turn correspond approximately to the diameter of the pipeline to be inspected. Instead of the short sides 19a, 19b of the rectangle, provisions may also be made, as an alternative, for the long sides 18a, 18b to be connected to one another by means of continuous, especially more or less semicircular arc segments (not shown), as this is indicated by means of a dash-dotted line 20 on the right-hand side of FIG. 7.

The above-described geometry of the carrier 1 imparts to said carrier the ability to pass satisfactorily through a pipeline to be inspected, on the one hand, by the carrier 1 being at first rotated about the longitudinal axis of the pipeline to the extent that its first cross section (FIG. 5) lies in the plane of bending of the pipeline (always in the drawing plane in FIG. 5), after which the carrier 1 can be passed through the pipe bend such that the underside 10 of the first cross section is moved past the inner radius of the pipe bend, while the top side 11 of the first cross section is passed by the outer radius of the pipe bend. Furthermore, a cover 7 of the carrier 1, which cover is used to mount the tools 2 (FIGS. 1 and 2), can be recognized in FIGS. 4 through 7 (as well as in FIG. 1), wherein the tool 2 itself can be moved to and fro through an opening 8 (FIG. 4) in the cover 7 between its operating position (FIG. 2) and its inoperative position (FIG. 3). The above-described geometry of the carrier 1 offers the tool or tools, on the other hand, a maximum possible space in order to be able to be accommodated more or less completely in the carrier 1, so that no components, which could lead, especially in a pipe bend, to blocking, will project from the carrier 1 during its passage through a pipeline.

While specific embodiments of the invention have been shown and described in detail to illustrate the application of the principles of the invention, it will be understood that the invention may be embodied otherwise without departing from such principles.

What is claimed is:

1. A device for inspecting and/or rehabilitating pipelines, the device comprising:
a carrier for passing through a pipeline, the carrier comprising a top side and an underside, wherein in a first cross section of the carrier, taken in a first plane, which plane includes a central longitudinal carrier axis that extends during use more or less parallel to a longitudinal axis of a straight section of the pipeline or axially aligned with the longitudinal axis of the straight section the pipeline, has end-side sections at the top side and is essentially straight or concave at the underside, wherein the end-side sections of a top side extend away from the respective outer ends of the essentially straight or concave underside in an arc-shaped and convex manner in a direction of the opposite outer end and wherein a radius of curvature or the radii of curvature of the end-side sections of the top side of the first cross section, equals or each equal more than 50% of a maximum distance of the underside from the top side; and
at least one of a camera and a tool arranged at the carrier.

2. A device in accordance with claim 1, wherein the radius of curvature or the radii of curvature of the end-side sections of the top side of the first cross section, which said end-side sections extend in an arc-shaped and convex manner and away from the respective outer ends of the underside, equals or equal at least 60% of the maximum distance of the underside from the top side.

3. A device in accordance with claim 1, wherein a concave transition area with a radius smaller than the radius or the radii of the end-side sections of the top side, is arranged between the outer ends of the essentially straight or convex underside of the first cross section of carrier in the first plane, and the end-side sections of the top side.

4. A device in accordance with claim 1, wherein the end-side sections of the top side of the first cross section of the carrier, which said sections extend in an arc-shaped and convex manner and away from the respective outer end of the underside, are essentially circular arc-shaped in the first plane.

5. A device in accordance with claim 1, wherein a central section, which extends essentially straight or concavely more or less in parallel to the underside of the first cross section, is arranged between the end-side sections of the top side of the first cross section of the carrier.

6. A device in accordance with claim 1, wherein a second cross section of the carrier, taken in a second plane, which is arranged at a right angle to the first plane and at a right angle to the central carrier axis is one of essentially circular and has curved sections with a radius of curvature with intermittent straight sections including central areas at opposite lateral sides, an underside central area and a top side central area.

7. A device in accordance with claim 6, wherein the carrier is essentially mirror symmetrical in relation to at least one of:
the first cross section; and
the second cross section.

8. A device in accordance with claim 6, wherein a third cross section of the carrier, taken in a third plane at a right angle both in relation to the first plane and in relation to the second plane, is essentially rectangular with corners having a circular arc-shape.

9. A device in accordance with claim 1, wherein the tool is connected to the carrier for movement to and fro between an inoperative position, in which it is arranged within the carrier, and an operating position, in which it projects from the surface of the carrier.

10. A device in accordance with claim 9, wherein the tool is pivotable about a pivot axis, which is essentially at right angles in relation to the first cross section of the carrier.

11. A device in accordance with claim 9, further comprising a hydraulically, pneumatically or hydropneumatically actuatable piston-and-cylinder unit wherein the tool is moved to and fro between an inoperative position and an operating position and pivoted about a pivot axis by means the piston-and-cylinder unit.

12. A device in accordance with claim 9, wherein the tool is arranged at one of the end-side sections of the top side.

13. A device in accordance with claim 1, wherein the carrier has a fixing means, which is used to fix the carrier in the interior of the pipeline.

14. A device in accordance with claim 1, further comprising a sliding eel, wherein the carrier is connected to the sliding eel.

15. A device in accordance with claim 1, wherein the sliding eel is fastened to the carrier pivotably about an axis that is at right angles in relation to the first plane.

16. A device in accordance with claim 15, wherein:
a concave transition area with a radius smaller than the radius or the radii of the end-side sections of the top side, is arranged between the outer ends of the essentially straight or convex underside of the first cross section of carrier in the first plane, and the end-side sections of the top side; and
the pivot axis of the sliding eel is arranged in one transition area.

17. A device in accordance with claim 1, further comprising a rotating means to rotate the carrier about the central longitudinal axis of the pipeline.

18. A device in accordance with claim 17, wherein the rotating means is connected to the carrier by means of a sliding eel.

19. A device in accordance with claim 17, wherein the rotating means has a first part connected to the carrier and a second part which is rotatable in relation to the first part about the central longitudinal axis of the pipeline and which can be fixed at the inner wall of the pipeline.

20. A device in accordance with claim 18, further comprising a hydraulic, pneumatic or hydropneumatic drive for driving at least one of the tool and the rotating means is arranged outside the carrier.

21. A device in accordance with claim 20, wherein the drive is arranged in a drive unit, connected to one of the tool and the rotating means by means of lines arranged in the sliding eel.
